(19) United States
(12) Patent Application Publication
(10) Pub. No.: US 2018/0215344 A1
(43) Pub. Date: Aug. 2, 2018

(54) INFORMATION PROCESSING SYSTEM, METHOD, APPARATUS, COMPUTER READABLE MEDIUM, AND COMPUTER READABLE PROGRAM FOR INFORMATION EXCHANGE IN VEHICLES

(71) Applicant: MOBILE INTELLIGENT ALERTS, LLC, Holmdel, NJ (US)

(72) Inventors: Thomas SANTORA, Holmdel, NJ (US); Steve Cratus OWENS, Barrington, NH (US)

(21) Appl. No.: 15/906,436

(22) Filed: Feb. 27, 2018

Related U.S. Application Data
(63) Continuation-in-part of application No. 15/019,565, filed on Feb. 9, 2016.
(60) Provisional application No. 62/566,749, filed on Oct. 2, 2017.
(60) Provisional application No. 62/481,179, filed on Apr. 4, 2017.
(60) Provisional application No. 62/464,005, filed on Feb. 27, 2017.
(60) Provisional application No. 62/211,314, filed on Aug. 28, 2015.
(60) Provisional application No. 62/114,275, filed on Feb. 10, 2015.

(51) Int. Cl. B60R 25/102; B60R 25/33; B60R 25/30; B60R 25/32; B60R 25/31; B60R 25/24; H04N 5/232; H04N 5/91

(52) U.S. Cl. CPC B60R 25/102; B60R 25/33; B60R 25/305; B60R 25/32; B60R 25/31; B60R 2025/1016; H04N 5/23238; H04N 5/91; B60R 2325/101; B60R 2325/103; B60R 25/24

(57) ABSTRACT

A system for alerting a user of a vehicle in an unexpected event. The system comprises a detector for detecting the unexpected event and a recording system comprising at least one camera for continuously recording video information concerning the vehicle. The recording system comprises a circular buffer for storing the video information recorded by the at least one camera and a device for controlling the circular buffer such that when the unexpected event occurs, the recording system only records additional video information to fill approximately one half of the circular buffer so that the circular buffer at least contains video information of before and while the unexpected event to the vehicle is occurring. A communicating device configured for sending the circular buffer, containing the video information of before and while the unexpected event to the vehicle is occurring, to at least one of a server and a mobile device.

### FIELD OF THE INVENTION

The present invention relates generally to systems and methods for alerting a user of a vehicle of an unexpected event, and automatically exchanging ID information. More specifically, the present invention relates to systems and methods for notifying or alerting a user of a vehicle in the event of a collision, and exchanging ID information between the vehicles involved in a collision.

### BACKGROUND OF THE INVENTION

In the past, the collection of evidence at accident scenes has always been piecemeal at best. The present technology is limited to the matching of such items as car parts, paint, etc. in order to determine the make and model of a vehicle.

Additionally, because of the split second time frames (and the trauma that can often be associated with such an event), eyewitness accounts of what transpired can either be unreliable in nature or non-existent.

To solve the above problems, the present invention employs a novel use of a present technology in the investigation of motor vehicle accidents. The technology referred to in this application is commonly known as “Mi Alerts.”

By using near field communication, it will now be possible to identify drivers who are involved in “hit and run” accidents.

More specifically, by the use of near field communication that would be left at the scene of such accidents, it will now be possible to bring to justice those who commit these “hit and run” crimes. A particularly gratifying use of this invention would be in bringing to justice those who commit the most heinous of these crimes: ones involving personal injury and death.

“Hit and run” accidents in the United States have increased fifteen percent over the past five years. On average, motor vehicles are involved in 3.5 million hit and run accidents each year. According to a report compiled by the National Center For Statistics and Analysis and released by the National Highway Traffic Safety Administration on Apr. 22, 2003, hit and run accidents account for one in five pedestrian fatalities.

In related art, U.S. Pat. No. 7,119,669 relates to a portable electronic device, like a cellular telephone, capable of detecting collisions between vehicles and notifying the proper authorities. The device includes a microprocessor and memory, in addition to an accelerometer and global positioning systems receiver. The memory includes at least one filter for screening out false positives, which are false collision detections. In one embodiment, the device determines its velocity.

U.S. Pat. No. 7,317,397 relates to a method and apparatus for using RPID's in the investigation of motor vehicle accidents, which involves the use of an apparatus that would be attached to specific areas of motor vehicles. Contained within this apparatus are a plurality of (code bearing) radio frequency identifier devices or “RFID's.”

U.S. Pat. No. 7,518,490 relates to an integrated processing unit that captures range images shot by CCD cameras which are respectively provided on front, rear, left and right sides of a vehicle and image processor. Location allocation unit creates a location-allocation model of an obstacle from the range images and road surface images (heights of images above road surface). Vehicular swept path calculating unit calculates a swept path of each representative point.

Collision decision calculates intersection of the obstacle of the location-allocation model with the swept paths of the representative points and judges whether the points cross the obstacle. When a representative point may possibly cross the obstacle, the point is enhanced and displayed together with the obstacle (object) on monitor.

However, with the wide spread use of smart phones throughout the world, one would like the collision information to be readily available on his/her cell phone. There is thus a need for an improved collision notification system that is easier to install when compared to prior art systems and one that works independently, sometimes without the need of embedded vehicular subsystems.

### SUMMARY OF THE INVENTION

The present invention is an improved collision notification system that automatically gathers information pertaining to parties or vehicles involved in an accident, and sends that information to not just parties involved in the accident but also to emergency personnel who can provide assistance in a timely manner.

Accordingly, one embodiment of the present invention is a system for alerting a user of a vehicle in an unexpected event, the system including a detection means for detecting an impact to the vehicle, and a communicating means configured to send information related to the impact to a remote server, emergency personnel and/or a mobile device. The unexpected event can be a collision by a second vehicle or a contact by a second vehicle, towing of the vehicle without authorization, or use of the vehicle without authorization. The system can further include a control means for categorizing a level of the impact according to a predetermined categorization table. The information related to the impact can include a license number of the second vehicle, driver information of a driver of the second vehicle, insurance information pertaining to the second vehicle, an image of the second vehicle, a video capturing the impact, and/or a unique identification information. The driver information can include a name of the driver, driver's license number and state issuing the driver's license. The insurance information can include a name of an insurance company and a policy number of the driver of the second vehicle. The unique identification information pertains to an identification of a second system associated with the second vehicle. The detection means can include one or more G-sensors or accelerometers. The communicating means can include a GSM unit, GPRS unit, NFC unit, and/or a Bluetooth unit. The system can also include one or more camera units configured to record images or videos of the second vehicle, and a GPS unit for determining location of the vehicle. The information related to the impact can include date of occurrence, time of occurrence, and location of occurrence of the event. The system can also include a power management means for powering the system.

Another embodiment of the present invention is an apparatus for alerting a user of a vehicle of an unexpected event, the apparatus including a detection unit for detecting an impact to the vehicle, and a communicating unit configured to send information related to the impact to a remote server. The unexpected event can be a collision by a second vehicle or a contact by a second vehicle, towing of the vehicle without authorization, or use of the vehicle without authorization. The apparatus can also include a control unit for categorizing a level of the impact according to a predetermined categorization table. The information related to the impact can include license number of the second vehicle, driver information of a driver of the second vehicle, insurance information pertaining to the second vehicle, an image of the second vehicle, a video capturing the impact, and/or a unique identification information. The driver information can include name of the driver, driver's license number and state issuing the driver's license. The insurance information can include name of an insurance company and policy number of the driver of the second vehicle. The unique identification information pertains to an identification of a second apparatus associated with the second vehicle. The detection unit can include one or more G-sensors or accelerometers. The communicating unit can include a GSM unit, GPRS unit, NFC unit and/or a Bluetooth unit. The apparatus can include one or more camera units configured to record images or videos of the second vehicle, and a GPS unit for determining location of the vehicle. The information related to the impact can include date of occurrence, time of occurrence, and location of occurrence of the event. The apparatus can also include a power management unit for powering the apparatus.

Another embodiment of the present invention is a method for alerting a user of a vehicle of an unexpected event, the method including a detection step for detecting an impact to the vehicle, and a communicating step for sending information related to the impact to a remote server and/or a mobile device. The unexpected event can be a collision by a second vehicle or a contact by a second vehicle, towing of the vehicle without authorization, or use of the vehicle without authorization.

In yet another embodiment, a feature of the present invention is to utilize a key fob for determining the distance the user is from the vehicle and adjusting the sensitivity of the accelerometers accordingly. This feature enables a first sensitivity when the vehicle is parked and a different second sensitivity when the vehicle is in motion.

Yet another embodiment of the present invention is to utilize a panoramic lens which is affixed to video recording equipment for viewing 360 degrees around the vehicle and thereby facilitate more complete and comprehensive capturing and recordation of relevant video data when an unexpected event occurs.

The method can also include a control step for categorizing a level of the impact according to a predetermined categorization table. The information related to the impact can include a license number of the second vehicle, driver information of a driver of the second vehicle, insurance information pertaining to the second vehicle, an image of the second vehicle, a video capturing the impact, and/or a unique identification information. The driver information can include a name of the driver, a driver's license number and state issuing the driver's license.

The insurance information can include a name of an insurance company and a policy number of the driver of the second vehicle. The unique identification information pertains to an identification associated with the second vehicle. The information related to the impact can include date of occurrence, time of occurrence, and location of occurrence of the event.

Another embodiment of the present invention is a computer readable program recorded on a non-transitory computer readable medium for executing a detection step for detecting an impact to the vehicle, and a communicating step for sending information related to the impact to a remote server and/or a mobile device. The unexpected event is a collision by a second vehicle or a contact by a second vehicle, towing of the vehicle without authorization, or use of the vehicle without authorization. The program can include a control step for categorizing a level of the impact according to a predetermined categorization table. The information related to the impact can include license number of the second vehicle, driver information of a driver of the second vehicle, insurance information pertaining to the second vehicle, an image of the second vehicle, a video capturing the impact, and/or a unique identification information. The driver information can include name of the driver, driver's license number and state issuing the driver's license. The insurance information can include name of an insurance company and policy number of the driver of the second vehicle. The unique identification information pertains to an identification associated with the second vehicle. The information related to the impact can include date of occurrence, time of occurrence, and location of occurrence of the event.

Yet another embodiment of the present invention is a non-transitory computer readable medium comprising the computer readable program according to the previous embodiment.

Terms “comprising” and “comprises,” as used in this disclosure, can mean “including” and “includes” or can have the meaning commonly given to the term “comprising” or “comprises” in US patent Law. Terms “consisting essentially of” or “consists essentially of,” if used in the claims, have the meaning ascribed to them in U.S. Patent Law. Other aspects of the invention are described in or are obvious from (and within the ambit of the invention) the following disclosure.

### BRIEF DESCRIPTION OF DRAWINGS

The accompanying drawings, which are included to provide a further understanding of the invention, are incorporated in and constitute a part of this specification. The drawings presented herein together with the description serve to explain the principles of the invention. In the drawings:

FIG. 1 is a schematic view of a system according to one embodiment of the present invention;

FIG. 2 is a schematic view of an apparatus, according to one embodiment of the present invention;

FIG. 3 is a schematic view of a system, according to one embodiment of the present invention;

FIG. 4 depicts steps involved in an information processing method, according to one embodiment of the present invention;

FIG. 5 depicts an impact classification table, according to one embodiment of the present invention;

FIG. 6 is a block diagram showing an example of an automobile alert apparatus, according to an example embodiment of the present disclosure;

FIG. 7 is a diagram showing an example of an automobile, according to an example embodiment of the present disclosure;

FIGS. 8a and 8b provide a flowchart illustrating an example process for providing automobile alert information, according to an example embodiment of the present disclosure;

FIG. 9 diagrammatically illustrates further features of an embodiment of the present invention utilizing a key fob;

FIG. 10 diagrammatically illustrates a rear view mirror with a deployed interior camera which provides 360 degree viewing of the interior and exterior of the vehicle; and

FIG. 11 diagrammatically illustrates the rear view mirror of FIG. 10 with the camera shown in its retracted position.

### DETAILED DESCRIPTION OF THE PREFERRED EMBODIMENTS

The invention according to one exemplary embodiment is a communication system 100 that utilizes sensors, a microprocessor/microcontroller, a memory device, and an online server, whereby information is captured and exchanged between these sensors, and transmitted via a wireless connection to an online server.

According to one exemplary embodiment, sensors may be placed within the bumpers and doors of a commercial vehicle or automobile, such as a passenger car. When any part of a vehicle that is equipped with the present system 100 hits or bumps another vehicle equipped with the same type of system 100, whether it be bumper to bumper, door to door, or bumper to door, etc., the associated sensors can detect the impact and exchange information with one another.

According to the embodiments of the present invention, these sensors will not only be able to exchange information with one another but also be able to detect the level of impact of the collision, thus identifying the extent of the damage inflicted by the other car. Each sensor can have its own unique identification (along with additional information, if necessary) that can be transmitted to the other sensor when impact takes place. Once this exchange of identification or information occurs between the sensors, it can then be transmitted, via a wireless connection, to the vehicle's operating system 100, while simultaneously being sent to a secure, online server.

Capturing, exchanging and transmitting information by these sensors and establishing a communication system 100 in order to facilitate and secure this information is the primary objective of the present invention.

The various embodiments in the present invention can be equipped with:
G-sensors (to measure impact)
GSM modem (to post all information online to a website)
Bluetooth module (to offer the information to a mobile device or an automobile computer installed within the vehicle)
NFC module (for bump detection and ID exchange), and/or
A GPS chip (embedded within the system 100 for tracker information)

Using the various embodiments of the present invention, a person will be able to identify another automobile if their vehicle is struck by that automobile. This function will be primarily utilized when someone is the victim of a hit and run (while parked or in transit) or when damage is done to their car by another's car door from impact while opening the door. The various embodiments of the present invention will be able to identify that vehicle through this system 100.

According to one embodiment, the various embodiments of the present invention are suitable for use in a vehicle or automobile whose basic function is to transmit information when a car accident, or some other event, occurs through a sensor located, for example, directly behind a car's front license plate. The various embodiments of the present invention use a sensory board that detects impact and movement, and sends that information to an online server, as well as the owner's mobile device, for example.

If only one car in the accident has the system 100 or apparatus according to the present invention, then an alert is sent to that owner's mobile device informing him/her that their car was bumped, dinged (by another car door) or smashed (by another car). The system 100 or apparatus is able to measure the degree of impact of the collision as well. However, if both cars in the accident have a system 100 or an apparatus, according to the present invention, then an alert is sent to both owner's mobile device, and the information of each driver (in the form of an identification number, for example) is exchanged between both drivers, along with being sent to an online secure database, where both drivers can be identified and thus eliminating all “hit and run” accidents.

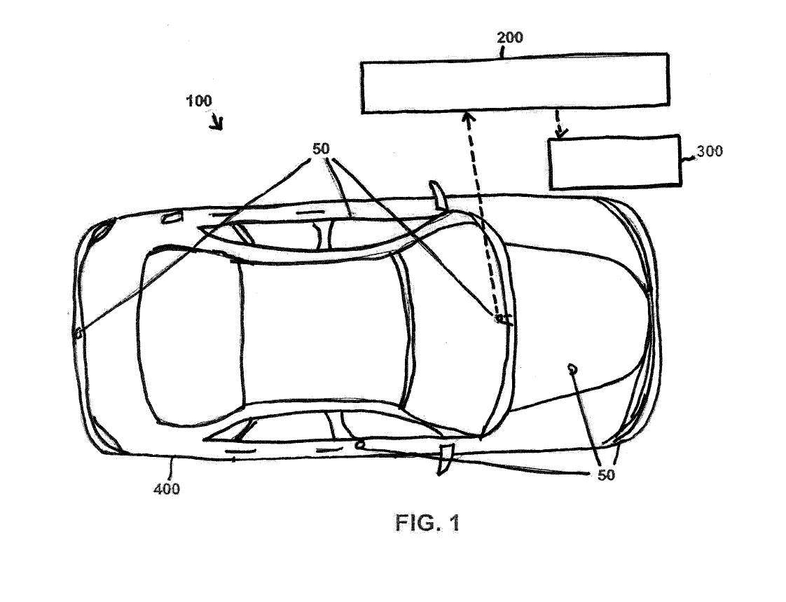

Turning now to the figures, FIG. 1 is a schematic view of a system 100 according to one embodiment of the present invention. As illustrated in FIG. 1, an information processing apparatus 50 can be deployed at variously locations on a vehicle, for example, a passenger car, according to one embodiment of the present invention. The various components of the apparatus 50 will be described in detail in the following paragraphs, however, as one skilled in the art can envision, any and all of the components of the apparatus 50 can be integrated into a vehicle to improve the aesthetics and/or performance of the apparatus. As described herein, an “apparatus” refers to an apparatus that works independently, without the need of embedded vehicular subsystems. A “system” as referred to herein refers to a system 100 that is embedded within the vehicular subsystems, for example, within a microprocessor or operating system of a vehicle, such as an automobile. Although the present invention applies to both variations, the use of these terms will be clear based on the context within the description.

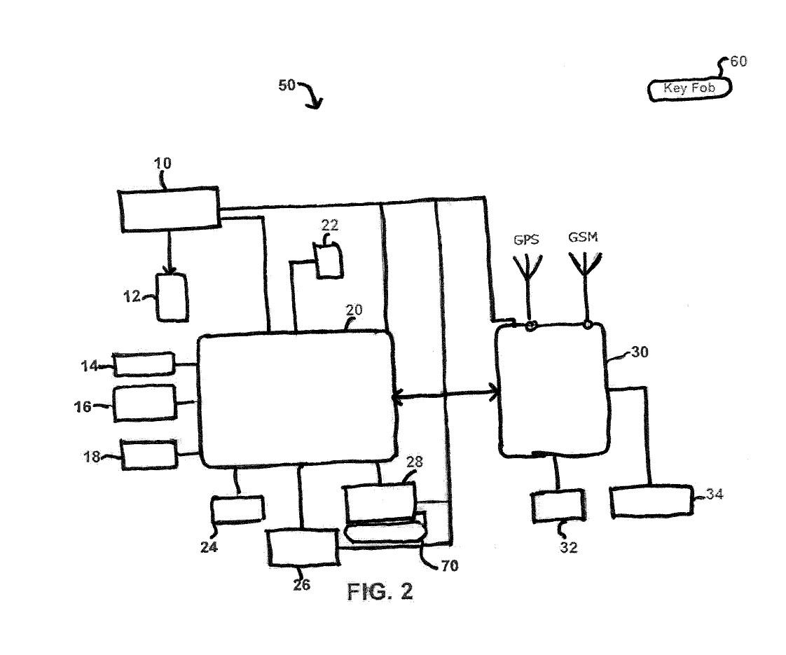

As shown in FIG. 1, a plurality of information processing apparatuses 50 can be distributed throughout a vehicle. Preferred locations are on top of the license plates on the front and/or the back, on the side doors, front and/or back, on the fenders in the front and/or back of the vehicle, and one in the center of the wind shield. A top level hardware design of each of the apparatuses 50 is shown in FIG. 2, for example. As shown in this figure, apparatus 50 includes a power management module 10, which receives power supply from a power source, from the car battery or a 12V mains supply, for example. The power management module 10 can be connected to a backup battery 12, such as a Lithium ion battery (1 100 mAG-1000 mAH), for example, which can be used in the event of a loss in power in the car. The power from the power management module 10 mainly supplies power to the control module 20, which may be a microcontroller or a microprocessor suitable for the purpose, with model no. STM32FI03RBT6 from ST Microelectronics being one suitable example of a microprocessor.

Control module 20 performs the basic functions of a microcontroller or a microprocessor, i.e., gathering data from the sensors connected thereto and processing the same so that such data can be used in further processes. The power from the power management module 10 also powers a G-sensor or accelerometer 28, which is an important element of the present invention. The accelerometer 28 is the device that detects the impact when another vehicle or object comes in contact with the present vehicle or at least slightly dings any portion thereof. As shown in FIG. 2, the power management module 10 also powers a Near Field Communication (NFC) or Bluetooth® module 26, which is capable of connecting to a mobile device (not shown) or any device equipped with a NFC or Bluetooth® capability.

Another important element of the apparatus 50 is the communication module 30, which can include GSM, GPRS, and GPS capabilities, for example. The communication module 30 collects information from the control module 20 and wirelessly transmits this information to the nearest cell phone tower. The information transferred from the communication module can be transferred to any remote server, which can be accessed using a smart phone application or any computer connected to the internet. Since the communication module also includes GPS capabilities, information pertaining to the global positioning of the vehicle can also be transmitted to the remote server. Any GPS, GSM antenna connector, known to one of ordinary skill in the art, may be used in this case, for example, a cable of U.FL to SMA connector may be used. Similarly, any external or internal SMA System 100/GSM antenna can be plugged from outside of the apparatus 50, for example.

It should be noted, however, that since the apparatus 50 includes a Near Field Communication (NFC) or Bluetooth® module 26, the information collected by the control module 20 can be readily transmitted to a device closest to it, for example, a person's cell phone with a Near Field Communication (NFC) or Bluetooth® capability. NFC may be preferred, in some instances, over Bluetooth®, however, because NFC does not require prior pairing.

The communication module 30, which includes a SIM card 32, such as a mini or micro SIM card, for example, can have a hinged type connector to hold the SIM card 32. The communication module 30 can also include LED lights 34 to indicate successful transmission of information (green light, for example), and unsuccessful transmission (red light, for example) when the transmission to the server 200 and/or the mobile device 300 is not successful. One example of a LED that may be used is a 12V System 100 lock, GSM status, GSM netlight type LED.

According to one embodiment, the control module 20 can include a volatile or non-volatile memory device 22, such as a micro SD card, which can temporarily or permanently store information related to the collision. The control module 20 can also be connected to a DIP switch 14, with 8 selectable switches for select SD card logging (on or off) and five selectable reporting periods, for example. The control module 20 can also be attached to an external interface 16, which can indicate a car engine state, for example, using a 2 input pin 12V (max) and 2 ADC input pin 12V (max). The control module 20 can additionally be connected to a Joint Test Action Group (JTAG) 24, which is a microcontroller programing interface.

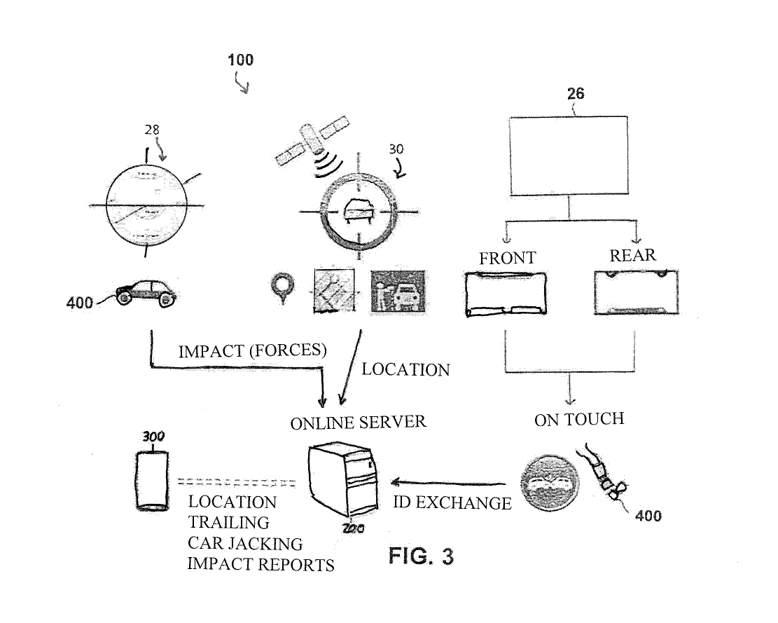

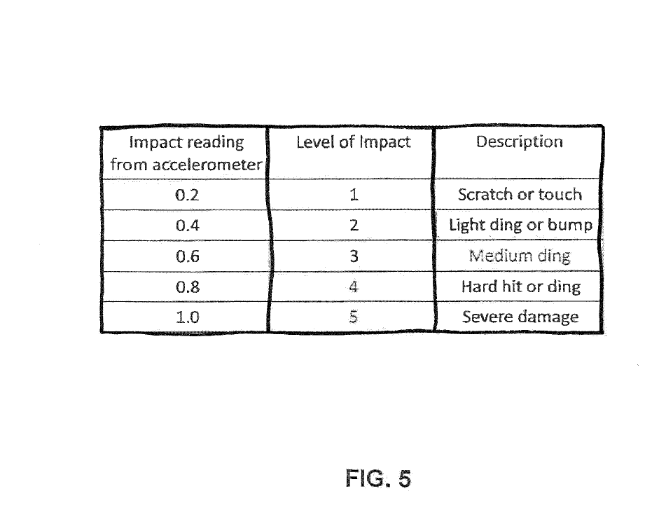

Turning now to FIG. 3, in there is shown a schematic of how the apparatus 50 works in the unexpected event of a collision. In the event of a collision or some other unexpected contact by another vehicle, as shown in the bottom right corner of the figure, for example, accelerometer 28 senses the impact or forces experienced by the vehicle, and sends the information to the control module 20. The control module 20 categorizes the impact reading from the accelerometer 28 according to a predetermined table, such as for example that shown in FIG. 5. As shown in FIG. 5, different readings from the accelerometer can indicates different levels of impacts, which can indicate different levels of accidents. For example, a reading of 0.2 from the accelerometer would be categorized as a level 1 impact, which could be interpreted as a scratch or touch by another vehicle or object.

Similarly, a reading of 0.4 from the accelerometer would be categorized as a level 2 impact, which could be interpreted as a light ding or bump by another vehicle or object. Similarly, a reading of 0.6 from the accelerometer would be categorized as a level 3 impact, which could be interpreted as a medium ding or bump by another vehicle or object. Similarly, a reading of 0.8 from the accelerometer would be categorized as a level 4 impact, which could be interpreted as a hard hit or ding by another vehicle or object. Similarly, a reading of 1.0 from the accelerometer would be categorized as a level 5 impact, which be interpreted as indicting severe damage to the vehicle.

The level of impact information and the information about the amount of damage done to the vehicle can be sent directly from the control module 20 to a user mobile device 300, such as a cell phone or a smart phone via the Near Field Communication (NFC) or Bluetooth® module 26. Alternatively, this information can be sent to the communication module 30, which now also has the location information (GPS reading) using the GPS chip.

According to one embodiment, the Near Field Communication (NFC) or Bluetooth® module 26 can be mounted on the front and/or rear license plates of the vehicle and it can exchange information related to the impact with the other vehicle. The information related to the impact can include, for example, license number of the second vehicle, driver information of a driver of the second vehicle, insurance information pertaining to the second vehicle, an image of the second vehicle, a video capturing the impact, and/or a unique identification information. The driver information can include name of the driver, driver's license number and state issuing the driver's license. The insurance information can include name of an insurance company and policy number of the driver of the second vehicle. The unique identification information pertains to an identification of a second apparatus associated with the second vehicle. The information related to the impact can include date of occurrence, time of occurrence, and location of occurrence of the event.

Any and all of this information can now be collected by the communication module 30 from the control module 20 and sent to a remote server 200 using, for example, the closest tower, or can be sent to a mobile device 300 directly. Although the various embodiments described herein refer to the use of a car and the unexpected event being a collision, the application of the present invention is not so limited. For example, the unexpected event can be a collision by a second vehicle or a contact by a second vehicle, towing of the vehicle without authorization, or use of the vehicle without authorization.

According to one embodiment, the various embodiments of the present invention can include one or more cameras, which can be located in any part of the vehicle, but preferably located right above the license plate in the front and/or the rear. The various embodiments of the present invention can include two or more additional, small, remote cameras that can be strategically placed throughout the vehicle, for example, above the back license plate and on each door as within the interior of the vehicle, e.g, in a rear view mirror of a dome light. When an accident occurs, the impact will trigger each camera to take a picture immediately after the collision, thus capturing a snapshot of the other car in the accident. According to one embodiment, the camera will also be able to take a short streaming video (as well as a picture) upon impact (a sensor will trigger the camera to start recording video and start taking pictures).

According to one embodiment, the information related to the impact can be uploaded to a server 200 via the communication module 30, and then this information can be downloaded via a mobile device 300, for example a cell phone, which may be equipped with the application necessary to download this information. Alternatively, the information related to the impact can be can be sent directly from the control module 20 to a mobile device 300, such as a cell phone or a smart phone via the Near Field Communication (NFC) or Bluetooth® module 26.

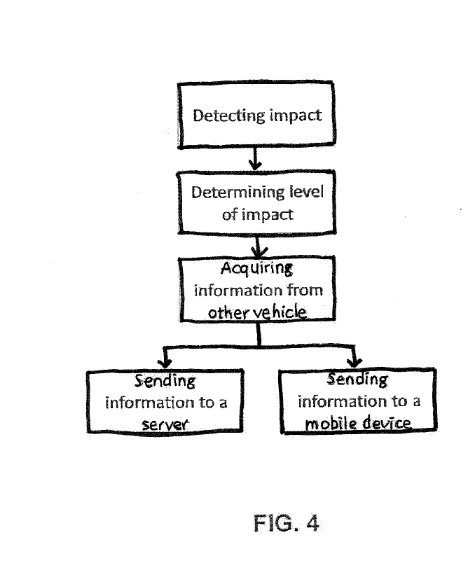

Another embodiment of the present invention is a method for alerting a user of a vehicle in an unexpected event, for example, that shown in FIG. 4. The method includes a detection step for detecting an impact to the vehicle, a determining step for determining the level of impact, an acquiring step for acquiring relevant information from the other vehicle, and a communicating step for sending information related to the impact to a remote server 200 and/or a mobile device 300. The method can also include a control step for categorizing a level of the impact according to a predetermined categorization table, such as that shown in FIG. 5, for example.

Another embodiment of the present invention is a computer readable program recorded on a non-transitory computer readable medium for executing the method described in the previous embodiment. Yet another embodiment of the present invention is a non-transitory computer readable medium comprising the computer readable program according to the previous embodiment. The computer readable medium may or may not be a part of the vehicular subsystems, such as the microprocessor or operating system within the vehicle. Additionally, although the various embodiments refer to a vehicle, such as a car, the invention is not limited as such. The systems, methods, and apparatuses described herein can be applied to any automobile including trucks, minivans, SUVs and the like.

Additional features various embodiments of the present invention include a built-in GPS unit that allows one to find his/her car in a crowded parking lot, the system alerts the user if his/her car is getting towed, alerts the user if his/her teenager is taking the car without prior permission, and alerts the user if his/her car is being stolen (if car is on the move without authorization or the system power is cut). The various embodiments of the present invention also alert the user if he/she cannot find their keys, and come with additional features such as a child finder, and/or a pet finder.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

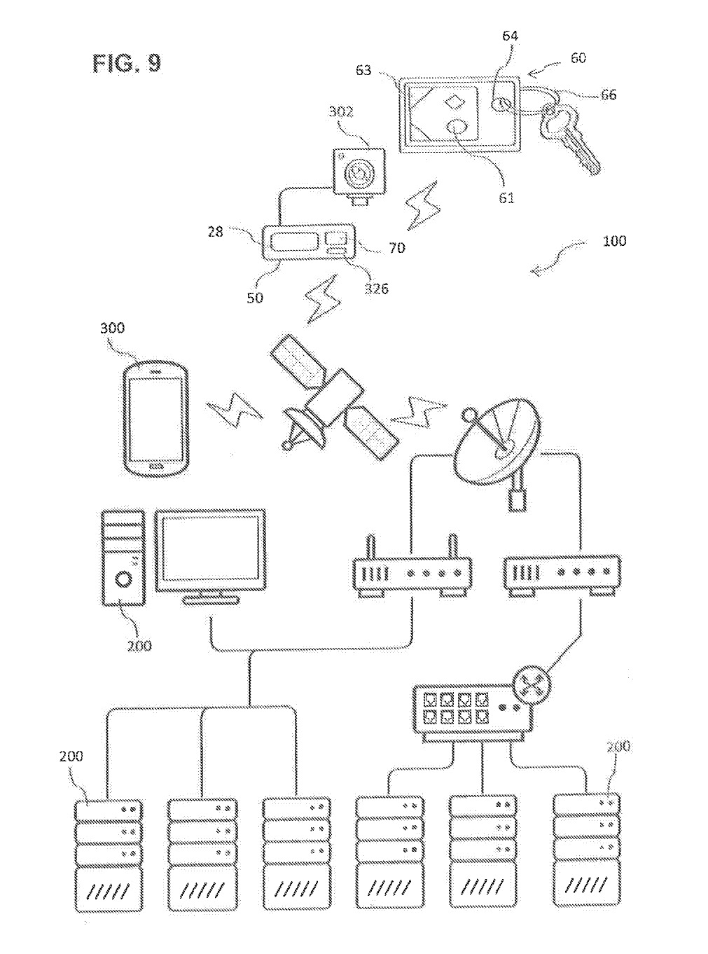

Another embodiment of the present invention includes an improved variation upon a conventional key fob 60. (See FIG. 2, and the further description concerning FIG. 9.) In these embodiments, this feature is useful in determining the distance the user, carrying the key fob 60, is from the vehicle equipped with system 100, according to the present invention, so that a sensitivity of the accelerometer(s) 28 can be adjusted based upon this determined distance of the user from the vehicle. This adjustment feature allows the accelerometer(s) 28 to have a first sensitivity, when the vehicle is stationary or parked, and a second, different sensitivity when the vehicle is in motion. Those skilled in the art will recognize that the acceleration to be detected by one of the accelerometer(s) 28 relating to an event, when the vehicle is parked or stationary, must be smaller than an acceleration event which occurs while the vehicle is in motion. Further, if the sensitivity level of the accelerometer(s) 28 is merely adjusted by determining whether or not the vehicle is running or operating, for example, the accelerometer(s) 28 may mistakenly determine that an unexpected event occurred when an occupant exits the vehicle and closes a door.

In addition, if the sensitivity level of the accelerometer(s) 28 is too low when the vehicle is running or operating, then when the vehicle runs over a pothole or some other bump in a road, this may inadvertently cause the system 100 to determine that an expected event occurred, which is undesirable. As a result, the sensitivity level of the accelerometer(s) 28, when the vehicle is running or operating, is typically much higher than the sensitivity level of the accelerometer(s) 28 when the vehicle is parked or stationary. For example, the sensitivity level of the accelerometer(s) 28, when the vehicle is running or operating, is preferably 2 to 20 times higher, and preferably about 10 times higher, than the sensitivity level of the accelerometer(s) 28 when the vehicle is parked or stationary. The present invention is directed at avoiding and preventing any false determination that an unexpected event occurred for the vehicle.

In addition to the above, the sensitivity of the accelerometers also generally depends upon whether the operator, having the key fob 60 in his or her possession, is located adjacent the vehicle. That is, the operator, having the key fob 60 in his or her possession, is located either within and the vehicle or less than 100-200 feet, for example, from the vehicle. Under such circumstances, as noted above, each one of the accelerometers 28 will typically require a relatively higher value in order for any one of the accelerometers 28 to trigger alarm and initial recording of video data by the system 100. By requiring each one of the accelerometers 28 to have a relatively high value before the accelerometers 28 activates the system 100, this prevents the system 100 from inadvertently be activated when the operator, or one of the vehicle occupants, accidentally bumps into or nudges the vehicle, such as when loading or unloading groceries, items, washing a car, etc. On the other hand, when the operator, having the key fob 60 in his or her possession, is located remote from the vehicle, e.g., at a distance greater than 100-200 feet from the vehicle, for example, each one of the accelerometers 28 will typically require a relatively lower value in order for any one of the accelerometers 28 to trigger and initiate recording of video data by the system 100.

The use of a key fob 60 facilitates reliable, consistent and automatic alteration of the sensitivity level of the accelerometer(s) 28 so that the sensitivity level of the accelerometer(s) 28 can have a relatively low sensitivity, when the user is in relatively close proximity to the vehicle (e.g., within the vehicle for a few yards or so from the vehicle), while the sensitivity level of the accelerometer(s) 28 can have a relatively high sensitivity, when the user is sufficiently spaced from the vehicle.

The key fob 60 can be constructed by using a TI CC1150 transmitter IC connected to a TI MSP430 uC. The uC periodically sends an encoded message, unique to the vehicle of the owner of the key fob 60, via the transmitter IC.

As diagrammatically shown in FIG. 2, a key fob receiver 70 is incorporated into the system 100 and can be made by employing a TI CC1101 transceiver that can be connected to the existing uC via the SPI bus. If the transceiver IC periodically receives the unique message from the associated key fob 60, then the sensitivity of the accelerometer(s) 28 is maintained at a relatively low level. However, if the uC does not receive the unique message from the associated key fob 60, then the system 100 automatically increases the sensitivity level of each accelerometer(s) 28.

Another embodiment of the present invention includes a variation utilizing a Bluetooth® feature of a conventional smart phone of an operator of the vehicle (once the operator's smart phone is synchronized to the system 100 of the vehicle) for adjusting the sensitivity of the accelerometer(s) 28. That is, when the system 100 is able to detect that the Bluetooth® feature of the smart phone of the operator, the system 100 knows that the operator is either driving the vehicle or located sufficiently close to the vehicle thus the accelerometer(s) 28 can be adjusted to have a higher sensitivity, while when the system 100 is unable to detect the Bluetooth® feature of the smart phone of the operator, the system 100 knows that the operator is located sufficiently far away from the vehicle, e.g., the vehicle is parked, and thus the accelerometer(s) 28 can be adjusted to have a lower sensitivity. Such adjustment feature allows the accelerometer(s) 28 to have a first sensitivity, when the vehicle is stationary or parked and the operator is located sufficiently far away from the vehicle and a second, different sensitivity when the operator is near the vehicle or the vehicle is being driven by the operator. Those skilled in the art will recognize that the acceleration to be detected by one of the accelerometer(s) 28 relating to an event, when the vehicle is parked or stationary, should be smaller than an acceleration event which occurs while the vehicle is in motion.

In yet another embodiment of the present invention, a 360° panoramic camera 302, such as the BubbleScope 360 Instant, is used to reduce cost and the complexity of the unit by reducing the number of cameras needed required, without sacrificing viewing angle of the camera. This panoramic camera 302 can be mounted in approximately the same location as a conventional dome light of the vehicle (or in any other central location of the vehicle) so that the panoramic camera essentially in view and video events which are occurring 360° within and around the exterior perimeter of the vehicle. It is to be appreciated that by using four cameras for viewing and recording unexpected events occurring about the front, the left side, the rear and the right side of the vehicle increase the cost of the system 100 by adding additional components and complexity to the circuitry, increases the amount of data that must be transmitted, and increasing the time needed to install the system 100 within the vehicle.

It is to be appreciated that the 360° panoramic camera 302 can comprises, instead of a single panoramic camera, both first and second removable cameras which each individually provide 180° of viewing so that both the first and the second cameras together provide 360° viewing of the vehicle. For example, the first camera is a forward facing camera and facilitates viewing of the forward travel direction of the vehicle while the second camera is a rearward facing camera and facilitates viewing in the opposite direction. In such instance, both the first and second cameras can be supported by but removably mounted to a rearview mirror, for example, of the vehicle.

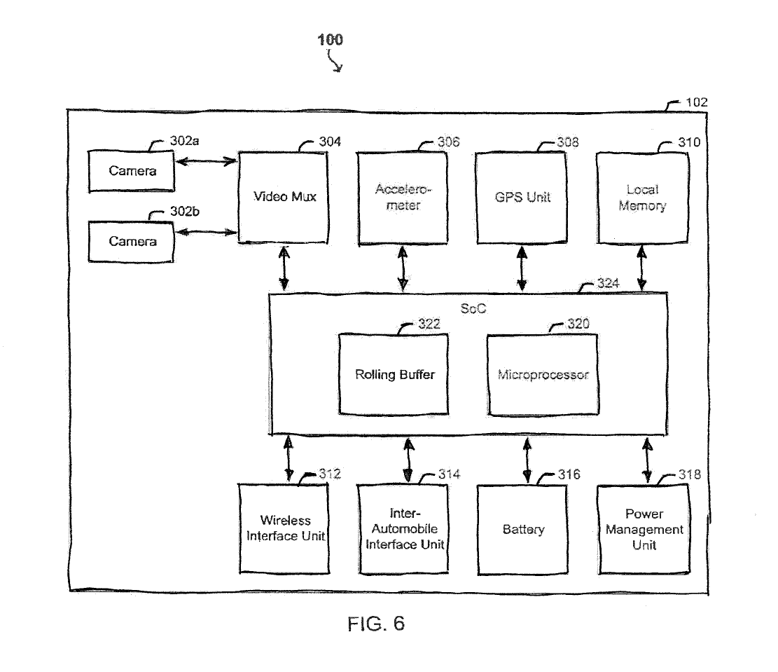

FIG. 6 is a block diagram showing an example of an automobile alert apparatus 102 of the system 100, which includes cameras 302a, 302b, a video multiplexer (mux)304, an accelerometer 306, a GPS unit 308, a local memory 310, a wireless interface unit 312, an inter-automobile interface unit 314, a battery 316, a power management unit 318, a microprocessor 320, a circular or rolling buffer 322, and a system-on-a-chip (SoC) 324. The cameras 302a, 302b, which may be referred to herein collectively as cameras 302, are provided to record images of the area surrounding the automobile.

The cameras 302 may be any suitable type of camera for recording collisions and/or relatively high speed motion, and may be adapted for recording in low light environments. For example, the cameras 302 may be wide angle video cameras. In an example embodiment, the cameras may be configured to record video images at one or more different frame rates (e.g., 7 FPS, 12 FPS, 15 FPS) and/or record still images at the same or higher resolution than the video images. The cameras 302 may connect to a video multiplexer 304 in any suitable manner (e.g., USB, wireless). The video multiplexer 304 may combine the captured video images from the cameras 302 into a stream of data to be processed and stored. The captured images may undergo image processing techniques (e.g., compression) by the microprocessor 320 and be stored as image data in the circular or rolling buffer 322. The circular or rolling buffer may have capacity to store a set amount of video data (e.g., 2,000 frames), which may equate to a certain number of video time (e.g., 30-45 seconds, for example). The circular or rolling buffer may generally overwrite the oldest frame with each new frame received to maintain the most recent video data (e.g., the last 30-45 seconds). The circular or rolling buffer may be any suitable form of memory (e.g., RAM, flash) and the image data may be stored as any suitable form of data (e.g., MPEG, JPEG)

The accelerometer 306 may be a tri-axial accelerometer to sense acceleration forces applied to the automobile in any direction. The accelerometer 306 provides accelerometer values or data which may be used by the microprocessor 320 to determine whether to trigger an alert based on accelerometer values of a first period of time. The accelerometer 306 provides accelerometer values or data analog or digital data representative of G force or the like. When the accelerometer values over a period of time indicate an acceleration greater than a predefined threshold has occurred, the microprocessor may determine that a collision has occurred, and an alert is triggered accordingly. For example, determining that a collision occurred may case a flag to be set or an interrupt to be processed. Upon the triggering of an alert, automobile alert information will be transmitted to the user device 300 to notify the user.

For example, accelerometer data the video data stored in the circular or rolling buffer 322 may be included with automobile alert information provided to the user. The accelerometer data may be used by the processor 320 to determine a level of impact which indicates a severity of a collision. Thus, a minor ding such as a door of another automobile bumping into the door of the automobile in parking lot, may be a low level impact. A fender bender that results in minor to moderate damage of a bumper or lights may be a medium level impact. A major collision that results in severe damage may be a high level impact. The level of impact may be determined based on a variety of factors, including the weight of the vehicle, placement of accelerometer 306, empirical testing, etc. Also, multiple different predefined thresholds may be used, which trigger different event based on the level of impact.

In an example embodiment, different motion sensing devices, such as one or more rotational sensors 306, gyroscopic sensors 306, or the like may be used in conjunction with accelerometer or in lieu of the accelerometer 306 to provide information which is used to determine whether the threshold level of collision occurs, thus triggering an alert. In an example embodiment, several accelerometers 306 may be provided in an alert automobile apparatus 102. In an example embodiment, a first accelerometer may be located in the front bumper, a second accelerometer may be located in the back bumper, and a third accelerometer may be located in a main unit that is mounted in the trunk of the automobile. In an example embodiment, a bus extender (not shown) is used in conjunction with the accelerometer(s) 306 to advantageously enhance the sensitivity achieved with the accelerometer(s) 306.

Further, the microprocessor 320 may use different predefined thresholds when the automobile is in different states (e.g., turned off, turned on, driving). In an example embodiment, the microprocessor determines whether the engine or motor of the automobile is turned on or off, and adjusts the predefined threshold to require a higher acceleration value to trigger an alert when the automobile is turned on or driving. Thus, the system 100 advantageously accounts for situations like hitting a pothole, which could trigger an alert if the automobile was parked in a parking lot, but does not warrant triggering an alert while driving. On the other hand, if the car is parked, the predefined threshold may safely be set at a relatively lower level to ensure that any collision, even if minor, is sensed by the system 100 and triggers an alert. The accelerometer data may conform to industry standard protocols or formats to allow for ease of integration and/or use with other systems that use accelerometer data.

The GPS unit 308 may be any suitable GPS unit or other unit for determining a location of the automobile. In an example embodiment, the GPS unit 308 (e.g., ps/2 GPS mouse) is advantageously mounted with an exterior antenna on the exterior of the automobile, to improve accuracy and performance of acquiring the current location of the automobile (e.g., latitude and longitude, street address). The GPS unit 308 provides location data to the microprocessor 320, which may then be provided with the automobile alert information for the user via the wireless interface unit 312. The location of the automobile when a collision occurs can be very important information or evidence, which may be disputed by the operator of an offending automobile.

In an example embodiment, the user may use the user device 300 to track the location of the automobile at any time on demand. The GPS data may conform to industry standard protocols or formats to allow for ease of integration and/or use with other systems that use GPS data. The GPS data may be stored in local memory 310, which may be any suitable memory storage device or unit. In an example embodiment, the local memory 310 may be flash memory or hard disk memory. For example, depending on system 100 requirements, the local memory 310 may have a wide range of sizes (e.g., 256 MB, 1 GB, 4 GB, 32 GB). Also, as discussed in further detail below, the local memory 310 may store a wide range of data, including video data, accelerometer data, automobile identification, power management data, etc.

When a collision occurs, the accelerometer 306 will output values indicative of the collision, and the microprocessor 320 uses the accelerometer data to determine when a collision occurs by determining whether an acceleration greater than a predefined threshold is sensed. In an example embodiment, the microprocessor 320 causes several communications to occur. For example, the inter-automobile interface unit 314 may communicate with an inter-automobile interface unit 314 located in the other automobile involved in the collision. Inter-automobile wireless communication may be performed between inter-automobile communication units 314 in different automobiles using a wireless communication protocol such as Bluetooth.

In an example embodiment, interautomobile wireless communication may be provided using any suitable wireless communication protocol (e.g., RFID, NFC, IrDA, Li-Fi). Multiple different wireless communication protocols may be used to insure successful data transmission between automobiles involved in a collision (e.g., Bluetooth and RFID, or RFID and IrDA). In an example embodiment, the inter-automobile interface unit 314 receives a unique automobile identifier from the other automobile which can be used to identify the automobile and the owner or driver of the other automobile. Advantageously, a hit and run driver is unable to succeed in evading responsibility for a collision, as the automobile identification data will be received by the inter-automobile interface unit 314 and stored in the local memory 310.

The wireless interface unit 312 may transmit the automobile alert information to a server system 104 of the remote server 200. For example, the wireless interface unit 312 may be configured to communicate via multiple protocols employed by cellular networks (e.g., 4G, 3G, GSM), wireless local area network (e.g., Wi-Fi), or satellite (e.g., VSAT). The automobile alert information which is transmitted by the wireless interface unit 312 may include data stored in local memory 310, such as accelerometer data and location data, and may also include the video data stored in the circular or rolling buffer 322. The accelerometer data, location data, and video data may all be time stamped, so the alert information may be further helpful for establishing the facts of what happened in a collision. In an example embodiment, the wireless interface unit 312 may continuously transmit any alert information which is ready to transmit if any network is available, so if alert data is being transmitted via Wi-Fi, which becomes unavailable, a 4G network may be used. In an example embodiment, the wireless interface unit 312 may transmit the automobile alert information directly to a user device 300, for example, when the user device 300 is a mobile device located within the automobile.

The battery 316 may provide power for the automobile alert apparatus 102, and may be any suitable rechargeable type battery (e.g., lithium ion). Power management unit 318 may manage the power distribution for all the components of the automobile alert apparatus 102. The power management unit 318 may provide a predefined voltage to the SoC 324 and any other components using a regulator or the like (e.g, linear regulator, a step down circuit). It should be appreciated that the battery 316 may be embodied as a component of the power management unit 318, and/or the battery 316 and power management unit 318 may interact with each other through the SoC 324 or separate from the SoC 324. The power management unit 318 may user power from an automobile battery (not shown) and recharge the battery 316 with power from the automobile to allow the battery 316 to provide power for extended periods of time when the automobile is turned off.

The microprocessor 320 may be provided in the SoC 324 (e.g., a BeagleBone) to provide a compact, low power, cost effective, and reliable means for processing of video data, accelerometer data, GPS data, automobile identification data, etc., for the automobile alert apparatus 102. The SoC 324 may be implemented in a variety of ways, and some of the components discussed above may be integrated on the SoC 324. For example, the circular or rolling buffer 322 may be implemented as part of the local memory 310, which may be part of the SoC 324. In an example embodiment, the automobile alert apparatus 102 may use other input devices 214. For example, the automobile alert apparatus 102 may record audio data, in addition to video data, using one or more microphones. This additional input data may be processed in a similar fashion as the image data discussed above, and be provided as alert information that the user may access.

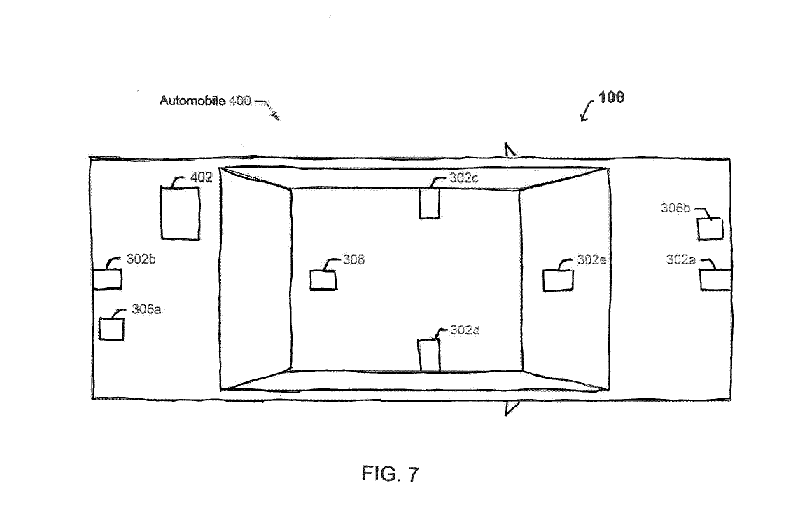

FIG. 7 is a diagram showing an example of an automobile, according to an example embodiment of the present disclosure. As illustrated in FIG. 7, the automobile 400 is shown from an overhead view and includes components of the automobile alert apparatus 102 mounted in various different locations of the automobile 400. A main unit 402 may be installed in a trunk of the automobile or in another interior compartment. The main unit 402 may include a SoC 324, along with a video multiplexer 304, an accelerometer 306, a local memory 310, a wireless interface unit 312, an inter-automobile interface unit 314, a battery 316, and a power management unit 314. The automobile 400 includes five cameras 302a, 302b, 302c, 302d, 302e. The camera 302a is mounted on the front bumper to capture images in the forward direction, the camera 302b is mounted on the rear bumper to capture images in the backward direction, while the cameras 302c and 302d are mounted on the interior of the left and right sides of the automobile 400, to capture images through the windows to the left and right of the automobile 400. Each camera 302 may have a wide angle view (e.g., 170 degree view). Thus, the cameras 302a, 302b, 302c, 302d may capture the full view surrounding the automobile in 360 degrees. Accordingly, any collision should be in the field of view and captured on at least one camera 302. The camera 302e may be provided on the interior of the automobile 400, for example, generally viewing the driver seat and passenger seat, a compartment within the vehicle (e.g., trunk, backseat), or the entire interior of the automobile 400. The cameras 302 may be wired (e.g., USB) to the main unit 402 or communicate wirelessly (e.g., Wi-Fi, 4g) with the main unit 402.

The automobile alert apparatus 102 also pushes video data from the wireless interface unit 312 of the automobile to the server system 104 (block 510). For example, if the automobile is turned off, when a collision occurs, the wireless interface unit 312 may immediately start transmitting the video data located in the circular or rolling buffer at the time of the collision. Accordingly, prior to overwriting the video data in the circular or rolling buffer, the video data from before the collision occurred may be pushed to the video server 504. However, the video data may take longer to transfer than the non-video alert data, and further, the video data continues recording for a period of time during the collision and after the collision, so the video data will continue to be pushed until there is no further video data to be pushed to the video server 504. If any interruption in network availability occurs, the wireless interface unit 312 may continuously transmit video data over any network that is available, and if no network is available, the video data will stored and transmitted whenever a network becomes available.

It is to be appreciated that if the vehicle is parked or stored for a prolonged period of time, more than a few days, then the power consumed by the system 100 can potentially drain much or all of the power from the vehicle battery. In order to combat this potential issue, the power management unit 318 of the system 100 is equipped with a motion detector 400 which facilitates temporary activation/deactivation of the system 100. That is, when the power management unit 318 switches the system 100 into a deactivated state, the entire system 100 is substantially inactive and in a power saving mode and thus does not consume any appreciable amount of electrical power. However, when either the motion detector 400 detects motion in or around the vehicle or one of the accelerometers 28, 306 is triggered or activated, due to the vehicle experiencing a sufficient impact, e.g., and accident or a person attempting to break into the vehicle, either the motion detector 400 or the accelerometer 28, 306 sends a signal to the power management unit 318 so that the system 100 is then reactivated and capable of recording events as the occur in and around the vehicle.

The system is typically program so that after the vehicle discontinues operation and the operator/occupant(s) leave the vehicle, the system 100 will normally operate in a fully powered mode for a predetermined period of time, e.g., anywhere from a few to many hours. Once this predetermined period of time expires, the power management unit 318 then switches the system 100 in to a power saving mode in which the system 100 is generally active but can be periodically activated, by the motion detector 400 in the event that the motion detector 400 detects movement in, on or around the vehicle. When the system 100 is operating in power saving mode, the motion detector 400 is fully powered and operational so as to be able to detect motion. As such, if the motion detector 400 detects any significant movement in the vicinity of the vehicle, e.g., within 20 to 30 feet or so, of the vehicle, the motion detector 400 sends a signal to the power management unit 318 which triggers activation of the system 100 and, in particular, the control module 20, the cameras 302, 302a, 302b, 302c, 302d, 302e, the circular or rolling buffer 322, etc., so that the system is then able to capture events as they occur in, on or around the vehicle. Since the motion detector 400 the detects movement occurring within the vicinity of the vehicle, the system 100 is activated and recording events occurring around the vehicle prior to any impact or theft occurring with respect to the vehicle. In the event that the motion detector 400 no longer detects any further movement in the vicinity of the vehicle for a predetermined time period, e.g., 1-10 or so, then the power management unit 318 switches the system 100 back over to the power saving mode until the motion detector 400 again detects movement which subsequently reactivates the system 100.

A second possibility of dealing with the steady and constant drain of electrical power from the battery or batteries, when the vehicle is parked or stored for a prolonged period of time, is for the system 100 to have both first and second modes of operation. That is, when the battery of the vehicle (and possibly a separate battery for the system 100) have an adequate supply of electrical battery power, the system will continuously operate in a conventional record/delete mode in which video data is recorded in the circular or rolling buffer 322 and such recorded video data continuously writes over and deletes previously record video data which was temporarily stored on the circular or rolling buffer 322, before any recorded information is sent to the cloud or some other desired storage device. It is to be appreciated that while the system 100 is operating in this first mode of operation, the system 100 consumes a significant amount of electrical power which tends to deplete the battery or batteries of the vehicle and system.

Once the remaining electrical power of the battery or batteries falls below a desired threshold, e.g., only 5-40% of the electrical power remains in the battery or batteries, then the system 100 switches to a power saving second mode of operation. When the system 100 operates in the power saving second mode of operation, the system 100 switches to a sleep mode in which most of the components of the system 100 are typically not active. That is, only the control module 20 and the accelerometer 28, 306 (and/or possibly the motion detector 400) are active and supplied with electrical power to continue to monitor any events occurring in and around the vehicle. The sleep mode significantly decreases the amount of electrical power being consumed by the system 100 and thus the permits the system 100 to continue operate for many more days while still being able to record video data occurring in and around the vehicle.

When the system 100 operates in the power saving second mode of operation, it is to be appreciate that the system 100 is only intermittently operating and recording video data i.e., only recording information when one of the accelerometers 28, 306 detects the vehicle experiencing a sufficient impact. Once a sufficient impact is detected by one of the accelerometers 28, 306, then a signal is sent to the control module 20 which activates at least one of the cameras 302 to commence recording video data and sending this recording information to the circular or rolling buffer 322 for storage. Prior to the circular or rolling buffer 322 writing over any of the just stored video data, the control module 20 will send this recorded video data to the cloud or some other designated or desired storage device to preserve this information for later retrieval. Once the event is terminated or after a predetermined period of time or operation, e.g., 30 seconds to a 10 minutes or so, the system 100 will then power back down so that only the control module 20 and the accelerometer 28, 306 are again supplied with electrical power and continue to monitor any events occurring in and around the vehicle. The above process is repeated each time that one of the accelerometers 28, 306 detects that the vehicle is experiencing a sufficient impact.

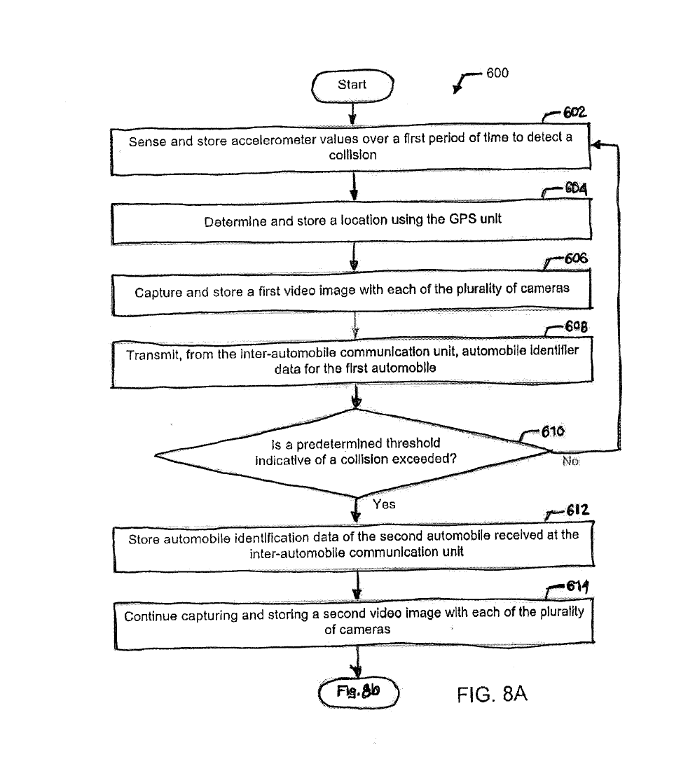

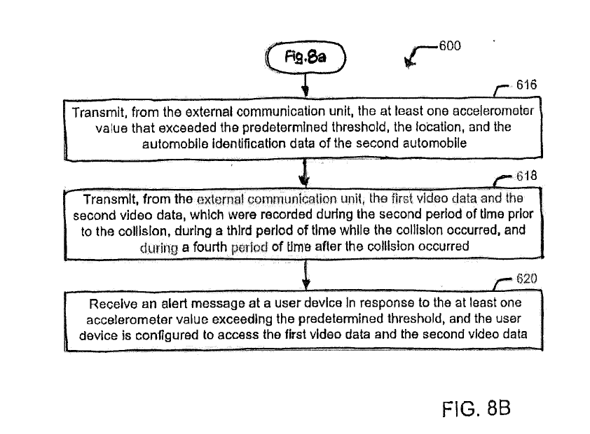

With reference to FIGS. 8A and 8B, an example process 600 of the system 100 may begin with sensing and storing accelerometer values over a first period of time to detect a collision (block 602). For example, accelerometer values that are sensed (e.g., every 0.02 seconds) are stored in a log as in time stamped log entries. The example process 600 further includes determining and storing a location with the GPS unit (block 604). For example, the GPS unit 308 unit may receive a fix approximately every ten seconds, which is stored in time stamped log entries in the local memory 310. The example process 600 further includes capturing a first video image with each of the plurality of cameras and storing first video data for each of the first video images captured by each of the plurality of cameras for a second period of time (block 606). For example, 45 seconds of video data for each of four exterior cameras 302 and one interior camera 302 is recorded in a circular or rolling buffer 322. The example process 600 further includes transmitting, from the inter-automobile communication unit, automobile identification data for the first automobile (block 608). For example, the automobile identification data may be a unique identifier (e.g., MAC address) which is broadcast from the inter-automobile interface unit 314 to uniquely identify the automobile and/or the owner or operator of the automobile to other automobiles. The server system 104 may store a list of each automobile with the unique identifier for that automobile. The server system 104 may implement privacy protocols to only provide information on users to other users when it is appropriate to release such information.

After the predetermined threshold is exceeded, the example process 600 includes continuing to capture and store a second video image with each of the plurality of cameras (block 614). For example, the cameras 302 continue capturing video images during and after the collision for a period of time (e.g., 45 seconds, 2 minutes, 5 minutes, 10 minutes), which are stored in the circular or rolling buffer 322. After the predetermined threshold is exceeded, the example process 600 includes transmitting, from the external communication unit, the at least one accelerometer value that exceeded the predetermined threshold, the location, and the automobile identification data of the second automobile (block 616). For example, log entries including the accelerometer data for the period of time preceding, during, and following the collision, GPS data, and the unique identifier of the other automobile (e.g., MAC address) are immediately transmitted to the server system 104.

Further, after the predetermined threshold is exceeded, the example process 600 includes transmitting, from the external communication unit, the first video data and the second video data, which were recorded during the second period of time prior to the collision, during a third period of time while the collision occurred, and during a fourth period of time after the collision occurred (block 618). For example, the circular or rolling buffer 322 may include a 45 seconds of video data for each camera prior to the collision, and an additional 5 minutes of video data from the time of the collision may be transmitted via the wireless interface unit (e.g., Wi-Fi or 4G) to the video server 504. Thus, the video data may show an automobile swerving between lanes prior to impact, clearly establishing fault for the collision. Log entries and video data may be processed in a first-in-first-out (FIFO) queue whenever any network is available. Further, after the predetermined threshold is exceeded, an alert message is received at a user device 300 in response to the at least one accelerometer value exceeding the predetermined threshold, and the user device 300 is configured to access the first video data and the second video data (block 620).

For example, the user receives a text message indicating that a level 3 impact has occurred, with the time and location of the collision, and with an indication that an offending automobile's identification information has been acquired with information regarding the offending automobile (e.g., license plate number, vehicle identification number, insurance policy number, driver's license number, owner name), and a link to download the video data showing prior to, during, and after the collision occurred from each camera angle (e.g., front, back, left, right, and interior). In an example embodiment, the server system 104 may control information provided to users and/or other third parties. For example, a message with information identifying another person, or with an enhanced level of identifying information, is only received by a user if both automobiles have detected a collision or detected a specified level of impact.

Turning now to FIG. 9, yet another embodiment of the present invention will now be described with reference thereto. As this embodiment is similar to the previously discussed embodiment, only the differences between this new embodiment and the previous embodiments will be discussed in detail while identical elements will be given identical reference numerals.

This embodiment is characterized by a record mechanism or button 61 on the key fob 60 so that an owner/operator of the vehicle has quick access to trigger instant recording of video and transmitting of the same, when required or desired, so that the user/operator does not have to fumble with an “app” on a cell phone, e.g., an iPhone, Android, for example, while driving in order to initiate recording of an event occurring in or around the vehicle. This feature benefits consumers by enabling efficient and easy use of the recording feature of the system 100, while sitting or driving the vehicle for example, thus ensuring a safer mode of operation while still enabling user/operator easily activation of the video recording feature.

That is, by the user or operator activation of the record button 61, without any one of the accelerometers 28, 306 being triggered due to a sufficient impact or reading, the record button 61 is linked to the control module 20 and the microprocessor 320 and pre-programmed to automatically initiate recording of the information being viewed by the one or more camera(s) 302 of the system 100 at the complete discretion of the user/operator. Such operator initiated recording feature may be useful for a variety of reasons. For example, if the user/operator, while driving the vehicle, witnesses a vehicle running a red light, a vehicle failing to stop at a stop sign, sees an accident occurring or about to occur, views a dangerous situation, is pulled over by the police and wants to record the encounter with the police, wants to record a sequence of events occurring within or adjacent the vehicle, etc., the operator has the ability to quickly and easily activate the system 100, by merely depressing the record button 61, and the system 100 is, thereafter, automatically activated and commences recording of the current events as they occur and also transmits the recorded information to a desired remote site, as discussed above, for safe keeping and subsequent use as necessary.

As diagrammatically shown in FIG. 9, when a user/operator activates the record button 61 on the key fob 60, the system 100 activates an associated mobile device video program or on-board video program which automatically instructs the desired amount of time of the most recent video, a few seconds or so, for example, to be sent to a secure server 200 or a personal mobile user device 300, such as a mobile phone, a personal tablet, and/or a smart watch. As with previous embodiments, a circular or rolling buffer 322 may include a buffer containing between 20-50 seconds of video data, for example, from each camera(s) 302 prior to the activation time of the button 61, and an additional 5 minutes of video data following activation of the button 61 which may be automatically transmitted to the secure server 200 or the personal mobile user device 300. While a standard time may be set, e.g., 30 seconds for example, the program may also enable users to alter the preferred time of recorded information/data to be transmitted to the secure server 200 or the personal mobile user device 300.

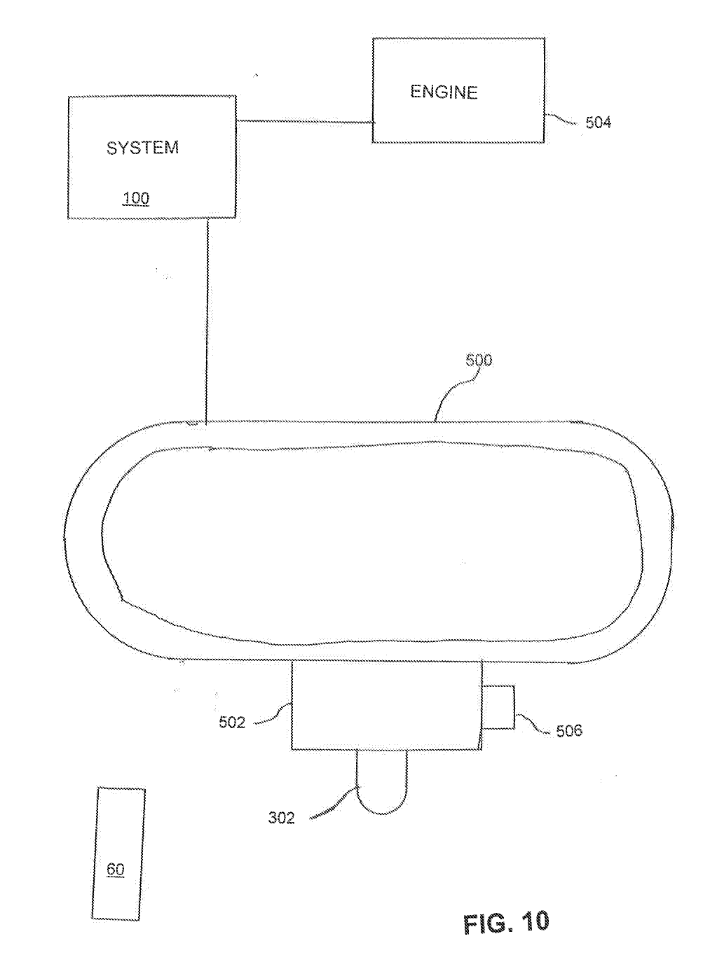

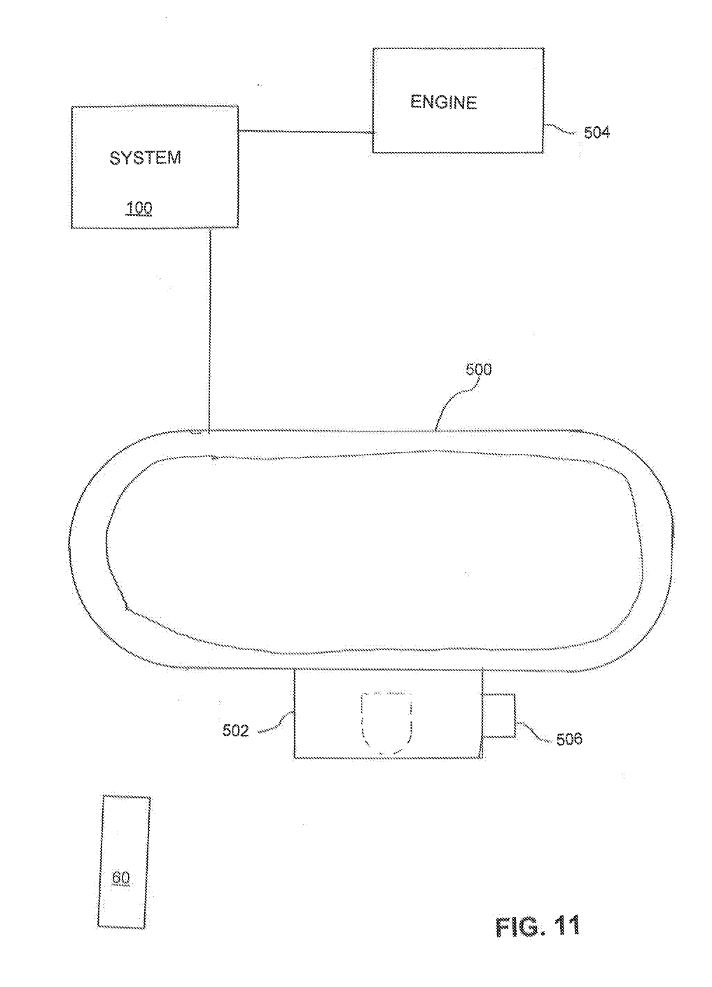

With reference now to FIGS. 10 and 11, a further embodiment of the present invention will now be discussed. As this embodiment is very similar to the previously discussed embodiment, only the differences between this embodiment and the previous embodiments will be discussed in detail while identical elements will be given identical reference numerals.

According to this embodiment, an interior component 500, e.g., a rearview mirror or an interior dome light for example, can be equipped with an interior deployable/retractable camera 302 (see FIG. 10) which provides 360 degree viewing of both the interior and the exterior of the vehicle when the camera 302 is in its deployed position. However, when the camera 302 is in its retracted position, as shown in FIG. 11, the camera 302 is completely housed and encased within a housing 502 of the interior component 500 and is thus unable to view or record events which occur within the interior and the exterior of the vehicle.

The interior deployable/retractable camera 302, having both a retracted position (see FIG. 11) and deployed position (see FIG. 10), can have utility, for example, in the car rental field where the occupant(s), while driving a rental vehicle, may possibly not want to record any events which occur within the vehicle, but such occupant(s) may still want the one or more exterior cameras, e.g., four exterior cameras 302a, 302b, 302c, 302d to capture a full view surrounding the vehicle, to be active continuously and record events as the occur. However, when the vehicle is parked and the occupants exit the (rental) vehicle, then the interior deployable/retractable camera 302 is moved into is deployed position, as shown in FIG. 10, for viewing and recording any event(s) which may occur while the occupant(s) is/are away from the vehicle. Typically, when the interior deployable/retractable camera 302 is moved into is active and deployed position, the four exterior cameras 302a, 302b, 302c, 302d generally still remain active so as to capture a full view around the exterior of the automobile and record events as they occur. The system 100, as shown in FIG. 10 with the deployable/retractable camera 302 in its deployed, provides complete viewing and recording of events as the occur both within and around the vehicle.

It is to be appreciated that the deployable/retractable camera 302 can be automatically deployed and retracted by a FOB 60 which is associated with the vehicle. That is, when the FOB 60, carried by the driver of the vehicle, is either located within the vehicle or in close proximity to the vehicle, e.g., 1 foot to 20 yards, the interior deployable/retractable camera 302 is or remains in its retracted position (see FIG. 11), but when the FOB 60 is located sufficiently far away from the vehicle, e.g., greater than 1 foot to 20 yards, then the system 100, electrically coupled to the interior deployable/retractable camera 302, will automatically activate the interior deployable/retractable camera 302 to move into its deployed position (see FIG. 10) and facilitate viewing and recording of events which occur within the interior and the exterior of the vehicle.

Alternatively, the deployable/retractable camera 302 can be automatically deployed and retracted by being electrically coupled or associated with the engine 504 of the vehicle. That is, when the engine is operating, the system 100 automatically moves the interior deployable/retractable camera 302 to, or the camera remains in, its retracted position (see FIG. 11), but when the engine is turned off, the system 100 automatically activates and moves the interior deployable/retractable camera 302 into its deployed position (see FIG. 10) to facilitate viewing and recording of events which occur within the interior and the exterior of the vehicle.

It is also contemplated that the deployable/retractable camera 302 can be automatically deployed and retracted by a Bluetooth® feature of a conventional smart phone of an operator of the vehicle (once the operator's smart phone is synchronized to the system 100 of the vehicle). That is, when the system 100 is able to detect that the Bluetooth® feature of the smart phone of the operator, the system 100 ensures that the interior deployable/retractable camera 302 is or remains in its retracted position (see FIG. 11), but when the system 100 is unable to detect the Bluetooth® feature of the smart phone of the operator, the system 100 knows that the operator is located sufficiently far away from the vehicle so that the system 100, electrically coupled to the interior deployable/retractable camera 302, will automatically activate the interior deployable/retractable camera 302 to move into its deployed position (see FIG. 10) and facilitate viewing and recording of events which occur within the interior and the exterior of the vehicle.

It is to be appreciated that the interior deployable/retractable camera 302 may also be equipped with a button or switch 506 which, when manually activated by an occupant of the vehicle, e.g., during an emergency situation, for recording a desired event, taking a picture, etc., will activate the interior deployable/retractable camera 302 to move into its deployed position (see FIG. 11) and commence viewing and recording of events which occur within the interior and the exterior of the vehicle.

Similarly to the previous embodiments, the communication module 30 collects information from the control module 20 and wirelessly transmits this information to the nearest transmitter, such as a cell phone tower. The information transferred from the communication module 30 can be transferred to any remote server, which can be accessed using a smart phone application or any computer connected to the internet. Likewise, while an automatic process is initially enabled to send the video to a secure server 200, the user may also alter such designation and instruct the program to automatically transmit the video via the wireless interface unit (e.g., Wi-Fi or 4G) to a video server 504, secure server and/or emergency personal reporting server.

In addition to the above described the record button 61, according to the present invention, the system 100 may also be equipped with a verbal warning system 326 which is directly connected to the control module 20 and the microprocessor 320 and controlled thereby. Accordingly, when one of the accelerometers 28, 306 is triggered or activated, due to the vehicle experiencing a sufficient impact, e.g., and accident or a person breaking into the vehicle, the system 100 commences recording the current events, as described above, and also activates the verbal warning system 326 which announces one or more preprogrammed announcements or warnings. For example, if one or more of the accelerometers 28, 306 is triggered due to a minor impact—e.g., a reading of 0.2 to 0.4 and the FOB key 60 is not located sufficiently adjacent the vehicle thereby indicating that the vehicle is most likely being broken into by one or more intruders
the verbal warning system 326 may announce to the intruder(s) that “the events are being recorded” and “the local authorities are being notified and are on their way.” Such verbal warning may deter the intruder(s) from proceeding further with the attempted break in or from attempting to leave the scene thereby making it easier for the authorities to apprehend the intruder(s). If, on the other hand, one or more of the accelerometers 28, 306 is triggered due to a major impact e.g., a reading of 0.6 or greater—thereby indicating that the vehicle is probably involved in an accident
the verbal warning system 326 may announce to the occupants and other individuals located inside or outside of the vehicle that “the local authorities have been notified and help is on the way.” It is to be appreciated that the system 100 can be preprogrammed to announce a variety of difference messages/announcements/warnings, depending upon whether or not the accelerometers 28, 306 is/are triggered and the particular at hand situation. In the event of an accident or an emergency, the microprocessor 320 can preprogrammed to and coupled to a transmitter to initiate a “911” call to the local authorities stating that the vehicle was just involved in an accident, identify the location of the accident
based upon the GPS coordinates—and request that the local authorities send assistance immediately.

Preferably the at least one camera of the vehicle will be equipped with an access point activation button that will automatically “link,” in a conventional manner, the at least one camera of the vehicle to a desired mobile device of the user, e.g., a cell phone, a tablet, a laptop, etc., in order to automatically synchronize the desired mobile device of the user and the “cloud.” Setup on the at least one camera (e.g., to set proper Cloud credentials) will typically be completed via a “mobile app” program which facilitates connection of the at least one camera to the cloud via conventional Wi-Fi. To assist with this, the at least one camera will be equipped with a Wi-Fi/4g access point activation button which, when activated, permits the at least one camera to operate and transmit filmed or stored information via Wi-Fi/4g or some other conventional transmission arrangement.

According to another aspect of the present invention, the system 100 includes a conventional GPS unit 308 for indicating whether or not the vehicle is stationary or in motion. The GPS unit 308 is connected to the control module 20 of the system 100 so that in the event that an event is detected by the system 100 and a few seconds after the detected event, e.g., 2-15 seconds or so after the detected event, the GPS unit 308 no longer indicates further motion or movement of the vehicle, the system 100 can automatically upload the data relating to the detected event to the cloud for storage and subsequent retrieval by the operator. However, in the event that an impact or event is detected by the system 100 and a few seconds after the event, e.g., 2-15 seconds or so after the detected event, the GPS unit 308 still indicates continued motion or movement of the vehicle in substantially the same direction and at substantially the same speed, the system 100 can then discount that event as a non-significant event, such as the vehicle merely drove over a pothole or a bump, and not upload any data relating to such non-significant event. Without this feature, it is to be appreciated that if the vehicle was traveling and drove over a pothole or a bump located along the roadway, this may inadvertently activate or trigger the accelerometer and provide a false indication of an event to the system 100. The system 100, as a result of being able to determine continued movement of the vehicle, via the GPS unit 308, at substantially the same speed and in substantially the same direction, can discount such non-significant event and determine that the vehicle merely drove over a pothole or a bump and not save the associated data to the cloud.

The system 100 can be controlled so that if the vehicle, during operation, both experiences an event, e.g., an impact for example, which is coupled with rapid braking or deceleration of the vehicle (vehicle deceleration at a rate of greater than about 7-10 feet/second), then the system 100 is actuated so as to automatically upload data relating to that event to the cloud for storage and subsequent retrieval by the operator. It is to be appreciated that the system 100 may also be set up and controlled so that if the vehicle, during operation, one experiences rapid braking or deceleration (e.g., braking at a rate of greater than 7-10 feet/second) of the vehicle but without any event being detected, then the system 100 can still automatically upload data relating to such rapid braking or deceleration to the cloud for storage for preservation and subsequent retrieval by the operator.

Alternatively, the system 100 may be set so that any time there is, for example, rapid braking or deceleration of the vehicle equipped with the system 100, or some other important event that should be reported to local law enforcement, e.g., an aggressive driver(s), an accident or some other emergency situation on a private or public road, highway, in a parking lot or on private property, etc., the relevant video data is automatically uploaded by the system 100 and sent to local law enforcement, through emergency SMS channels, so that the local law enforcement can then view and undertake necessary action after viewing such video data.

According to one embodiment, the system 100 may be set up so that the system 100 is either automatically “armed” or “disarmed” based upon the proximity of either the key fob 60, or possibly a phone of the user which is equipped with Bluetooth capability, to the system 100. That is, when the key fob 60 or a user's phone with Bluetooth capability is located closely adjacent or in the vicinity of the vehicle equipped with the system 100, e.g., within 100-200 feet of the vehicle, the system 100 is automatically deactivated while when the key fob 60 or a user's phone equipped with Bluetooth capability is sufficiently far away from the vehicle with the installed system 100, e.g., greater than 100-200 feet away from the vehicle, the system 100 is automatically activated. In addition, it is to be appreciated that the system may be automatically armed when the vehicle is locked by the user and automatically disarmed when the vehicle is unlocked by the user. As a result, the sensitivity of the system 100 can be adjusted based upon locking/unlocking of the vehicle.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. A system for alerting a user of a vehicle in an unexpected event, the system comprising:
a detection unit for detecting an unexpected event occurring within or near the vehicle;
a motion detector which facilitates temporary activation/deactivation of the system in order to conserve power;
a recording system comprising at least one camera for installation in the vehicle and continuously recording video information concerning the vehicle;
the recording system additionally comprising a circular buffer for storing the video information recorded by the at least one camera;
a control device electrically connected to the recording system for controlling the circular buffer such that when the unexpected event, as detected by the at least one of G-sensors or accelerometers, occurs, the recording system only records additional video information to fill one half of the circular buffer so that the circular buffer at least contains video information of before the unexpected event to the vehicle and while the unexpected event to the vehicle is occurring;
a key fob, coupled to the system, for indicating to the system a distance of the user from the vehicle, and the system adjusting a sensitivity of the at least one of the G-sensors or the accelerometers based on the distance of the user from the vehicle; and
a communicating device electrically connected to the recording system and configured for sending the video information, stored in the circular buffer, of before the unexpected event to the vehicle and while the unexpected event to the vehicle is occurring, to at least one of a server and a mobile device;
a means for detecting the presence of the user of the vehicle being sufficiently near the vehicle; and
a means for changing a sensitivity of the detection unit based upon whether or not the user of the vehicle is sufficiently near the vehicle.

2. The system according to claim 1, wherein the unexpected event is one of a collision by a second vehicle or a contact by a second vehicle, towing of the vehicle without authorization, or use of the vehicle without authorization.

3. The system according to claim 1, further comprising a control means for categorizing a level of the impact according to a predetermined categorization table, the level of impact being determined based on data from the at least one of G-sensors or accelerometers and a weight of the vehicle.

4. The system according to claim 2, wherein the video information comprises at least one of a license number of an impacting second vehicle, an image of the impacting second vehicle, or video capturing the impact and a unique identification information.

5. The system according to claim 4, wherein the unique identification information pertains to an identification of a second system associated with the second vehicle.

6. The system according to claim 1, wherein at least one of:
the detection unit comprises at least one of G-sensors or accelerometers installed in the vehicle for detecting the unexpected event to the vehicle;
the communicating device comprises a GSM unit, GPRS unit, NFC unit, and/or a Bluetooth unit; and
the one or more camera units configured to record images or videos of the second vehicle.

7. The system according to claim 1, wherein the at least one camera is either a panoramic camera for viewing and recording video of the unexpected event as the unexpected event occurs; or
a plurality of cameras enclosed within a housing for viewing 360 degrees and recording video of the unexpected event as the unexpected event occurs and sending a single frame of the video either prior to or along with the video;
a GPS unit for determining location of the vehicle;
the video information comprises date of occurrence, time of occurrence, and location of occurrence of the event;
a power management means for powering the system; and
a panoramic lens affixed to said camera.

8. An apparatus for alerting a user of a vehicle in an unexpected event, the apparatus comprising:
a detection unit for detecting an unexpected event occurring within or near the vehicle;
a motion detector which facilitates temporary activation/deactivation of the system in order to conserve power;
a recording system comprising at least one camera for continuously recording video information concerning the vehicle;
the recording system comprising a circular buffer for storing the video information recorded by the at least one camera;
a control device electrically connected to the recording system for controlling the circular buffer such that when the unexpected event, as detected by the at least one of G-sensors or accelerometers, occurs, the recording system only records additional video information to fill one half of the circular buffer so that the circular buffer at least contains video information of before the unexpected event to the vehicle and while the unexpected event to the vehicle is occurring; and
a key fob, coupled to the system, for indicating to the system a distance of the user from the vehicle, and the system adjusting a sensitivity of the at least one of the G-sensors or the accelerometers based on the distance of the user from the vehicle;
a communicating device configured for sending the circular buffer, containing the video information of before and while the unexpected event to the vehicle is occurring, to at least one of a server and a mobile device;
a means for detecting the presence of the user of the vehicle being sufficiently near the vehicle; and
a means for changing a sensitivity of the detection unit based upon whether or not the user of the vehicle is sufficiently near the vehicle.

9. The apparatus according to claim 8, wherein
the unexpected event is one of a collision by a second vehicle or a contact by a second vehicle, towing of the vehicle without authorization, use of the vehicle without authorization, a break in or vandalism to the vehicle or another event which occurs at the vehicle without the owner being present;
the control device categorizes a level of the impact according to a predetermined categorization table;
the video information comprises at least one of a license number of an impacting second vehicle, an image of the impacting second vehicle, or video capturing the impact and a unique identification information;
the video information comprises video of both the vehicle and at least one perpetrator who causes impact to the vehicle;
the one or more camera units are configured to record images or videos of the second vehicle;
the apparatus further includes at least one panoramic camera for viewing and recording video of the unexpected event as the unexpected event occurs;
the communicating unit comprises at least one of a GSM unit, GPRS unit, NFC unit and a Bluetooth unit; and
a GPS unit for determining location of the vehicle.

10. The apparatus according to claim 8, wherein the unexpected event is one of a collision by a second vehicle or a contact by a second vehicle, towing of the vehicle without authorization, or use of the vehicle without authorization; and the video information related to the unexpected event comprises date of occurrence, time of occurrence, and location of occurrence of the event; and
the detection unit comprises at least one of G-sensors or accelerometers installed in the vehicle for detecting the unexpected event.

11. The apparatus according to claim 8, further comprising a power management unit for powering the apparatus.

12. A method for alerting a user of a vehicle in an unexpected event, the method comprising:
providing means for changing a sensitivity of the detection unit based upon whether or not the user of the vehicle is sufficiently near the vehicle;
using a motion detector to temporary activation/deactivation of the system in order to conserve power;
determining a distance of a key fob from the vehicle and adjusting a sensitivity of the detection unit based on the distance of the key fob from the vehicle;
using at least one camera to continuously record video information concerning the vehicle;
storing the video information recorded by the at least one camera in a circular buffer;
controlling the circular buffer with a control device such that when the unexpected event occurs, only recording additional video information to fill one half of the circular buffer so that the circular buffer contains at least video information of before and while the unexpected event to the vehicle is occurring; and
sending, via a communicating unit, the circular buffer, containing the video information of before and while the unexpected event to the vehicle is occurring, to at least one of a server and a mobile device.

13. The method according to claim 12, further comprising:
defining the unexpected event as one of a collision by a second vehicle or a contact by a second vehicle, towing of the vehicle without authorization, use of the vehicle without authorization, a break in or vandalism to the vehicle or another event which occurs at the vehicle without the owner being present;
defining the video information as video of both the vehicle and at least one perpetrator who causes impact to the vehicle;
categorizing, with the control device, a level of the impact according to a predetermined categorization table; and
defining the information related to the impact as at least one of a license number of the second vehicle, driver information of a driver of the second vehicle, insurance information pertaining to the second vehicle, an image of the second vehicle, a video capturing the impact, and a unique identification information.

14. The method according to claim 12, further comprising defining the information related to the impact as at least one of a license number of the second vehicle, driver information of a driver of the second vehicle, insurance information pertaining to the second vehicle, an image of the second vehicle, a video capturing the impact, a unique identification information, a date of occurrence, a time of occurrence, and a location of occurrence of the event.

15. The system according to claim 1, wherein a key fob for determining the distance of the user from the vehicle and adjusting accelerometer sensitivity according to user's location, and the key fob includes a record button which, upon activation, transmits a signal to the system to activate the recording system and commence recording of information via the at least one camera.

16. The system according to claim 1, wherein the system further comprises a verbal warning system which is connected to a control module of the system which controls the verbal warning system, and the verbal warning system issues a verbal message based upon a reading of an accelerometer, and
the apparatus further comprises verbal warning system which is connected to a control module of the apparatus which controls the verbal warning system, and the verbal warning system issues a verbal message based upon a reading of an accelerometer.

17. The apparatus according to claim 8, wherein the apparatus includes a key fob with a record button, and upon activation of the button of the key fob, a signal is communicated to the apparatus to activate the recording system and commence recording of information via the at least one camera.

18. The method according to claim 12, further comprising at least one of:
providing a record button on the key fob which, upon activation, communicates a signal to the system to activate the recording system and commence recording of information via the at least one camera; and
providing a verbal warning system which is coupled to the control module and controlled thereby, for issuing a verbal message, via the verbal warning system, based upon a reading of an accelerometer.

19. The system according to claim 1, wherein an interior component is equipped with an interior deployable/retractable camera for providing 360 degree viewing, the camera, when in its retracted position, is completely encased within a camera housing and is thus unable to view and record events which occur within the interior and the exterior of the vehicle, but when the camera, when in its deployed position, facilitates viewing and recording of events occurring both within the interior and the exterior of the vehicle.

20. The system according to claim 1, wherein at least one of:
the interior component is one of a rearview mirror and an interior dome light;
the vehicle has both the interior deployable/retractable camera and exterior cameras arranged for capturing a full view surrounding the vehicle and recording events as the occur;
the deployable/retractable camera is automatically deployed and retracted by a FOB which is associated with the vehicle such that when the FOB is either located within the vehicle or in close proximity to the vehicle, the interior deployable/retractable camera is in its retracted position, but when the FOB is located sufficiently far away from the vehicle, then the system, electrically coupled to the interior deployable/retractable camera, automatically activates the interior deployable/retractable camera to move into its deployed position and facilitate viewing and recording of events which occur within the interior and the exterior of the vehicle;
the deployable/retractable camera is automatically deployed and retracted by an engine which is associated with the vehicle such that when the engine is operating, the interior deployable/retractable camera is in its retracted position, but when the engine is turned off, then the system, electrically coupled to the interior deployable/retractable camera, automatically activates the interior deployable/retractable camera to move into its deployed position and facilitate viewing and recording of events which occur within the interior and the exterior of the vehicle; and
the interior deployable/retractable camera is equipped with a button or switch which, when manually activated by an occupant of the vehicle activates the interior deployable/retractable camera into its deployed position and for viewing and recording of events which occur within the interior and the exterior of the vehicle.
